(19) United States
(12) Patent Application Publication
(10) Pub. No.: US 2011/0249354 A1
(43) Pub. Date: Oct. 13, 2011

(54) DISK STORAGE APPARATUS AND METHOD FOR SERVO CONTROLLING

(75) Inventors: Tatsuhiko KOSUGI, Ome-shi (JP); Takeshi HARA, Ome-shi (JP); Satoshi YAMASHITA, Yokohama-shi (JP)

(73) Assignee: KABUSHIKI KAISHA TOSHIBA, Tokyo (JP)

(21) Appl. No.: 12/984,879

(22) Filed: Jan. 5, 2011

(30) Foreign Application Priority Data
Apr. 12, 2010 (JP) 2010-091549

(51) Int. Cl. G11B 20/00

(52) U.S. Cl. 360/29; G9B/20

(57) ABSTRACT

According to one embodiment, a disk storage apparatus includes a disk and a servo demodulator. The disk has a servo area, in which a first phase servo pattern, a second phase servo pattern that is in phase with the first servo pattern, and a third servo pattern that is inverse in phase to the first and second servo patterns. The third servo pattern comprises at least two phase servo pattern segments. The servo demodulator is configured to perform a phase servo demodulating process that includes integration operation on integration sections of the same ratio, using a read signal read from the servo area by a head.

### CROSS-REFERENCE TO RELATED APPLICATIONS

This application is based upon and claims the benefit of priority from Japanese Patent Application No. 2010-091549, filed Apr. 12, 2010; the entire contents of which are incorporated herein by reference.

### FIELD

Embodiments described herein relate generally to a phase servo control technique for use in disk storage apparatuses.

### BACKGROUND

Disk storage apparatuses (hereinafter referred as “disk drives” in some cases), a representative example of which is a hard disk drive, perform servo control to move the head to a target position over the disk. The servo control may be the phase servo control using servo data containing a phase servo pattern. In the phase servo control, the phase servo patterns (phase servo burst signals) recorded in servo areas are integrated and demodulated. Position data representing the position the head has over the disk is thereby generated.

In the phase servo control, phase servo patterns must be integrated over a certain section in order to demodulate the phase servo patterns. If the phase servo patterns are integrated over a relatively long section, position data of high accuracy can indeed be generated. If the phase servo patterns are integrated over a relatively long section, however, the head will moves out of detecting range within the section (integration section) over which the phase servo patterns are integrated. Consequently, the position that the head has over the disk cannot be correctly detected.

This problem is not so large if the head moves at low speed. If the head moves relatively fast, however, the problem will become prominent. The moving speed (seek speed) of the head depends on the track density of the disk. The higher the track density, the higher the seek speed of the head will be. The speed with which the phase servo patterns can be demodulated will be inevitably limited in the phase servo control. This speed should be increased, because the track density is considered to increase in the future. That is, it is demanded that the phase servo patterns should be reliably demodulated in the phase servo control even if the head moves at high seek speed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram explaining the configuration of a disk drive according to an embodiment;

FIG. 2 is a block diagram explaining the major components of the read/write channel incorporated in the disk drive according to the embodiment;

FIGS. 3A and 3B are diagrams explaining the configuration of the servo data used in the disk drive according to the embodiment;

FIGS. 4A, 4B and 4C are diagrams explaining how the integration module operates in the disk drive according to the embodiment;

FIGS. 5A, 5B and 5C are other diagrams explaining how the integration module operates in the disk drive according to the embodiment;

FIGS. 6A and 6B are diagrams explaining a section over which the integration module operates in the disk drive according to the embodiment;

FIGS. 7A and 7B are diagrams explaining another section over which the integration module operates in the disk drive according to the embodiment;

FIGS. 8A and 8B are diagrams explaining a section over which the integration module operates in a disk drive according to another embodiment;

FIGS. 9A and 9B are diagrams explaining a section over which the integration module operates in a disk drive according to still another embodiment;

FIG. 10 is a diagram explaining a speed compensation process performed in the embodiment;

FIG. 11 is a diagram explaining another speed compensation process performed in the embodiment;

FIG. 12 is a diagram explaining still another speed compensation process performed in the embodiment;

FIGS. 13A and 13B are diagrams explaining a further speed compensation process performed in the embodiment;

FIG. 14 is a diagram explaining exemplary phase servo patterns used in the embodiment; and

FIG. 15 is a conceptual diagram of one of the phase servo patterns shown in FIG. 14.

### DETAILED DESCRIPTION

Various embodiments will be described hereinafter with reference to the accompanying drawings.

In general, according to one embodiment, a disk storage apparatus includes a disk and a servo demodulator. The disk has a servo area, in which a first phase servo pattern, a second phase servo pattern that is in phase with the first servo pattern, and a third servo pattern that is inverse in phase to the first and second servo patterns. The third servo pattern comprises at least two phase servo pattern segments. The servo demodulator is configured to perform a phase servo demodulating process that includes integration operation on integration sections of the same ratio, using a read signal read from the servo area by a head.

[Configuration of the Disk Drive]

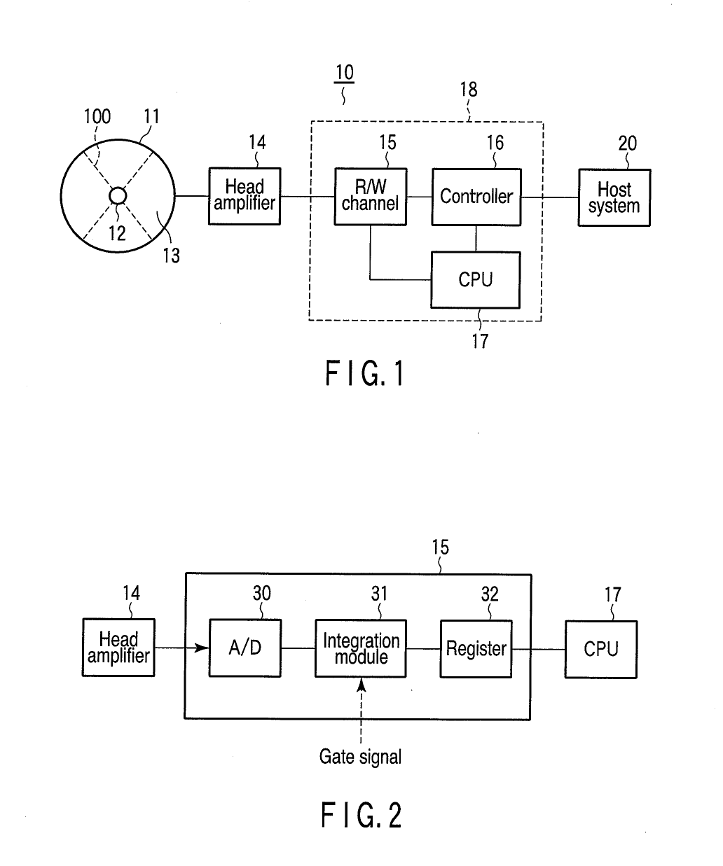

FIG. 1 is a block diagram explaining the configuration of a disk drive according to an embodiment. FIG. 2 is a block diagram explaining the major components of the read/write channel incorporated in the disk drive shown in FIG. 1.

As FIG. 1 shows, the disk drive 10 has a disk 11, a spindle motor 12, and a head 13. The disk 11 has servo areas (servo sectors) 100, which will be described later. The spindle motor 12 rotates the disk 11. The head 13 includes a read head element and a write head element and is configured to write and read data to and from the disk 11.

The disk drive 10 further has a head amplifier 14, a read/write (R/W) channel 15, a disk controller 16, and a microprocessor (CPU) 17. The R/W channel 15, disk controller 16 and CPU 17 are integrated together in a system-on-chip 18.

The head amplifier 14 amplifies a signal (read data) the head 13 has read from the disk 11 and supplies the signal to the R/W channel 15. The head amplifier 14 also converts a signal (write data) output from the R/W channel 15 and supplies the current to the head 13. The R/W channel 15 includes a read channel and a write channel. The read channel is a signal processing circuit that reproduces data from the disk 11. The write channel is a signal processing circuit configured that records data on the disk 11. The write channel the main function of encoding the write data. Herein, the function of the read channel will be described, but that of the write channel will not be explained.

The R/W channel 15 decodes the read signal the head 13 has read from a data area (data sector) of the disk 11. The R/W channel 15 also decodes the servo data contained in a read signal the head 13 has read from a servo area 100 of the disk 11. The servo data contains address data and a phase servo pattern (phase servo burst signal).

The disk controller 16 is an interface, which uses the data stored in a buffer memory (not shown), controlling the data transfer between the R/W channel 15 and a host system 20. The CPU 17 uses the servo data demodulated by the R/W channel 15, performing servo control on the head 13. The host system 20 is a digital apparatus, such as a personal computer or a digital TV receiver, which uses the disk driver 10 as an external storage device.

FIG. 2 is a block diagram showing a part of the read channel of the R/W channel 15. More precisely, FIG. 2 shows the major components of the read channel, which serve to demodulate phase servo patterns in the present embodiment. As shown in FIG. 2, the R/W channel 15 includes an analog-to-digital converter 30, an integration module 31, and a register 32.

The analog-to-digital converter 30 converts the servo signal contained in a read signal supplied from the head amplifier 14, to a digital signal. As will be explained later, the integration module 31 performs integration over an integration section that accords with a gate signal coming from the CPU 17 as will be, in order to demodulate the phase servo pattern contained in the servo signal. The integration module 31 performs discrete Fourier transformation (DFT). The register 32 holds the result of the operation the integration module 31 has performed. From the register 32, the CPU 17 acquires the result of the operation the integration module 31 has performed, and generates position data (phase data) that is necessary for the servo control.

[Phase Servo Demodulation]

The phase servo modulation performed in this embodiment will be explained below.

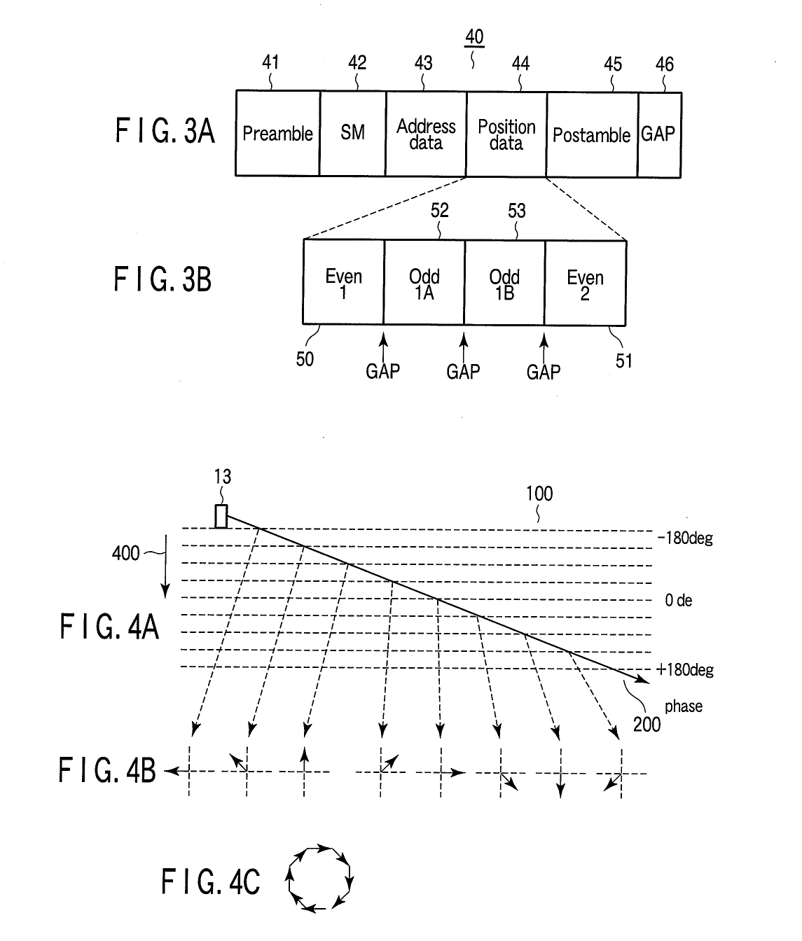

FIGS. 3A and 3B are diagrams explaining the configuration of the servo data 40 recorded in a servo area 100 of the disk 11. As shown in FIG. 3A, the servo data is composed of a preamble 41, a servo mark (SM) 42, address data 43, position data (servo burst signal) 44, a postamble 45, and a gap (GAP) 46. The address data 43 represents a track address (cylinder address) and a sector address. The CPU 17 identifies the number of the track at which the head 13 is positioned, from the track address demodulated.

The position data 44 is a phase servo burst signal from which to generate position data that represents the position the head 13 assumes in the track. As shown in FIG. 3B, the position data 44 is composed of a first phase servo pattern (Even 1) 50, a second phase servo pattern (Even 2) 51 that is in phase with the first servo pattern 50, and a third servo pattern (Odd) that is inverse in phase to the first and second servo patterns 50 and 51. The third servo pattern is split into a phase servo pattern segment (Odd 1A) 52 and a phase servo pattern segment (Odd 1B) 53. The phase servo patterns 50 to 53 are spaced apart by gaps (GAP).

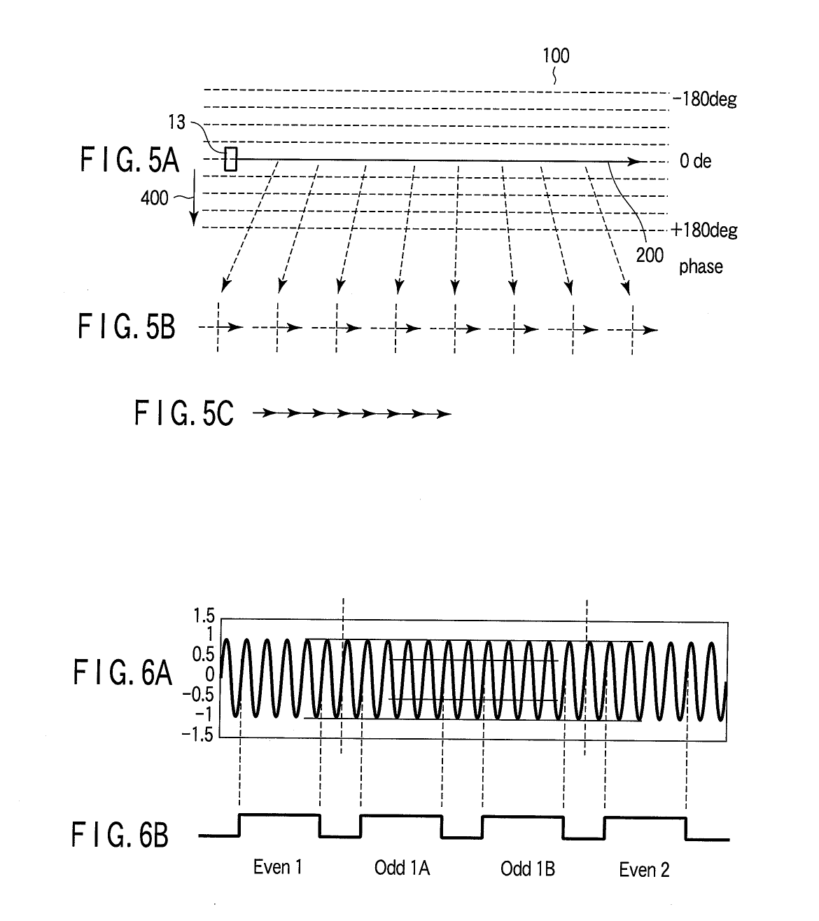

FIGS. 4A, 4B and 4C and FIGS. 5A, 5B and 5C are diagrams explaining the integration (DFT operation) the integration module 31 performs in accordance with the locus 200 in which the head 13 moves. In FIG. 4A and FIG. 5A, arrow 400 indicates the radial direction of the disk 11.

As seen from FIG. 4A, the head 13 reads the position data 44 (i.e., phase servo pattern) from a servo region 100 as it moves across the servo region 100 at a prescribed speed. Assume that the phase servo pattern is composed of first and second phase servo patterns (Even 1 and Even 2) of known type, and a third phase servo pattern (Odd) inverse in phase to the first and second phase servo patterns. Then, the R/W channel 15 outputs the result of the DFT operation, i.e., vectors that change in part, ranging from −180° to +180°, as shown in FIG. 4B. The CPU 17 performs speed compensation, synthesizing the vectors, i.e., the result of the DFT operation, and generating position data (phase data) that represents the position of the head 13. That is, the position data has been generated from the lengths of the vectors.

In the conventional configuration of phase servo patterns, the section over which the integration module 31 performs the DFT operation is long. More specifically, the three parts of each phase servo pattern (i.e., Even 1, Odd and Even 2), which are subjected to integration, have a ratio of 1:2:1 in terms of length. That is, the part Odd is twice as long as either Even part. The part Odd is inevitably only half resistant to speed, in comparison with either part Even. Therefore, if the CPU 17 synthesizes the vectors (i.e., result of DFT operation) as shown in FIG. 4C, while the head 13 is moving at high speed (or high seek speed), the vector will rotate through 360°, attaining no length (zero length). Consequently, the position of the head 13 cannot be detected while the head 13 is moving at high speed (or high seek speed).

The head 13 may read the phase servo pattern from the servo area 100 while remaining at a certain position in the servo area 100, not moving at all as shown in FIG. 5A. In this case, the integration module 31 of the R/W channel 15 outputs a DFT operation result of 0° as shown in FIG. 5B. The CPU 17 therefore synthesizes the vectors (i.e., results of the DFT operation), generating a vector of ideal length as shown in FIG. 5C.

As pointed out above, the track density of the disk 11 has increased in recent years. The moving speed of the head 13 has become high in proportion to the track density. The integration module 31 should therefore perform the DFT operation over a longer section than before. If the CPU 17 performs speed compensation to synthesize the vectors (i.e., results of the DFT operation), while the head 13 is moving at high speed (or high seek speed), the vector length calculated will be zero. That is, the vector length reduces to zero during the phase servo demodulating process. The phase component can no longer be defined. Consequently, the position data for the head 13 cannot be generated at all.

In this embodiment, the third phase servo pattern (Odd) of the phase servo burst signal 44 is split into two segments, i.e., phase servo pattern segment (Odd 1A) 52 and phase servo segment (Odd 1B), as shown in FIG. 3B. This shortens the integration section over which the DFT operation is performed. Phase servo demodulation is achieved that reliably demodulates the position data (phase data) representing the head position is therefore achieved even if the head 13 moves at high speed (or seeking the target track at high speed).

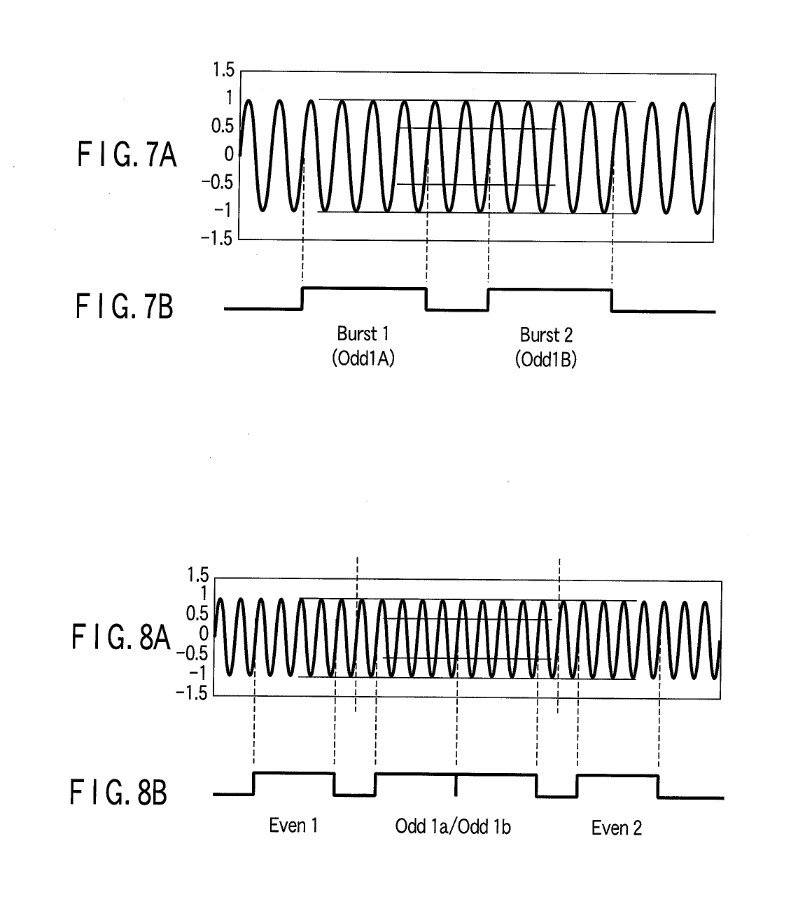

FIGS. 6A and 6B and FIGS. 7A and 7B are diagrams that explain the sections over which the integration module 31 operates in the embodiment. The integration module 31 performs DFT operation on such a read signal waveform (i.e., phase servo burst signal 44) as shown in FIG. 6A, over the section that accords with a gate signal supplied from the CPU 17. In this case, servo pattern part Even 1, servo pattern part Even 2 and phase servo pattern segments Odd 1A and Odd 1B, which define the integration section, have a ratio of 1:1:1:1 in length.

FIGS. 7A and 7B are magnified views of the phase servo pattern segments Odd 1A and Odd 1B shown in FIGS. 6A and 6B, respectively. As seen from FIGS. 7A and 7B, the integration module 31 performs DFT operation, integrating a 4-cycle read signal waveform (sine waveform).

FIGS. 8A and 8B are diagrams explaining a second embodiment. In the first embodiment described above, a section over which no integration is performed exists because a gap exists between the phase servo pattern segments Odd 1A and Odd 1B as shown in FIG. 7B. In the second embodiment, no gaps exist between the phase servo pattern segments Odd 1A and Odd 1B as shown in FIG. 5B. Hence, the phase servo patterns signal is shorter by a gap.

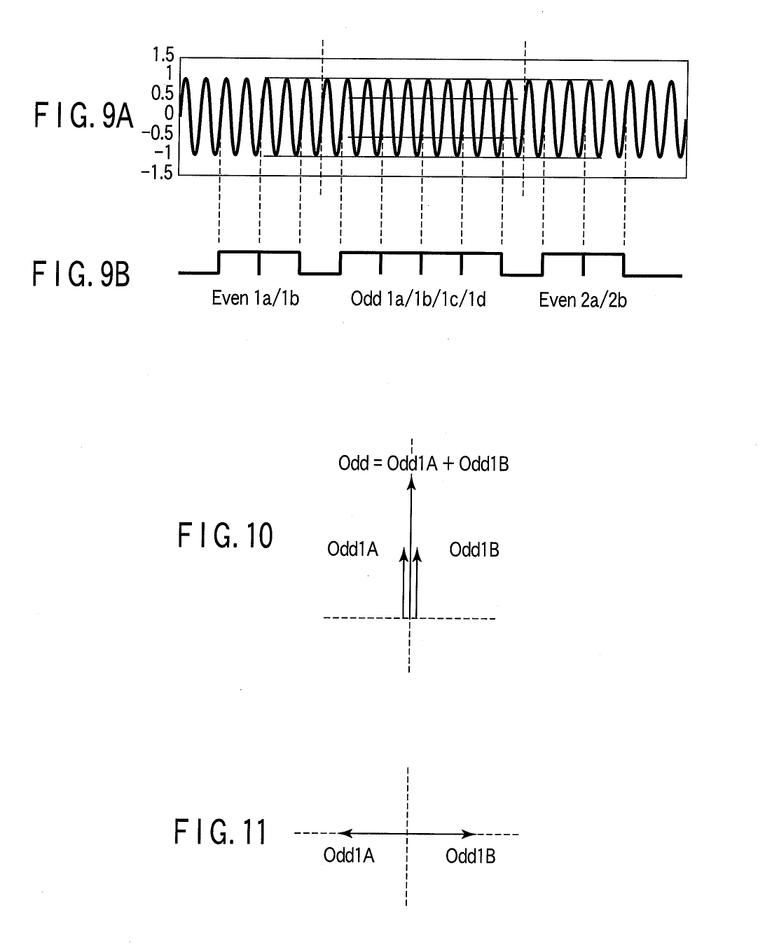

FIGS. 9A and 9B are diagrams explaining a third embodiment. In the first embodiment described above, the phase servo pattern (Odd) is split into two segments (i.e., phase servo pattern segments Odd 1A and Odd 2A) as shown in FIG. 7B. In the third embodiment, the phase servo pattern (Odd) is split into four segments, i.e., phase servo pattern segments Odd 1a, Odd 1b, Odd 1c and Odd 1d as shown in FIG. 9B. Further, as shown in FIG. 9B, too, the first phase pattern (Even 1) is split into two segments (i.e., phase servo pattern segments Even 1a and 1b), and the second phase pattern (Even 2) is split into two segments (i.e., phase servo pattern segments Even 2a and 2b).

In the second and third embodiments so configured as described above, the phase servo pattern is split into more segments than in the first embodiment, whereby the DFT operation can be reliably performed on each phase servo pattern over a shorter section.

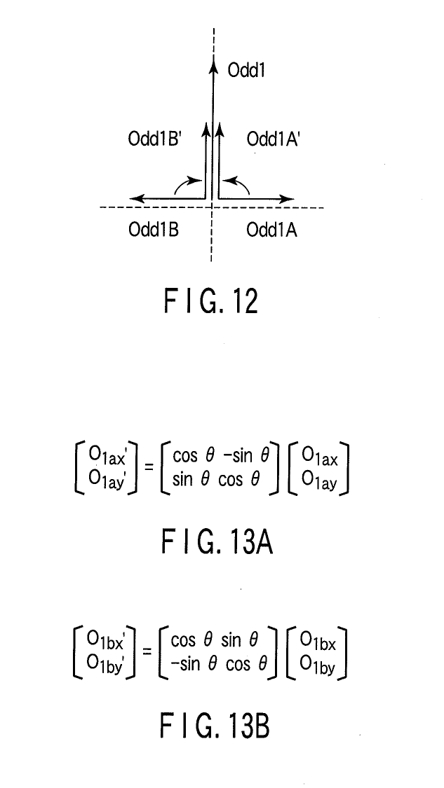

FIG. 10, FIG. 11, FIG. 12 and FIGS. 13A and 13B are diagrams explaining a speed compensation process performed during the phase servo demodulation in the embodiment described above.

As shown in FIG. 10, the vectors of the segments Odd 1A and Odd 1B, which have resulted from the DFT operation performed on the phase servo pattern segments split from the third phase servo pattern (Odd), are identical in direction if the head 13 is not moved at all (that is, the seek speed is zero). Hence, the CPU 17 synthesizes (adds) the vectors acquired from the register 32, thereby generating the position data representing the position of the head 13.

If the head 13 is moved at a certain seek speed, the vectors of the segments Odd 1A and Odd 1B are inverse in direction as shown in FIG. 10. The vectors of the segments Odd 1A and Odd 1B will cancel each other, reducing the sum of the vector lengths to zero. In view of this, the CPU 17 of the embodiment first corrects a phase deviation resulting from the speed and then adds the vectors as shown in FIG. 12, thereby calculating a significance vector length. Note that the phase deviation between the vectors of the segments Odd 1A and Odd 1B, which results from the speed, can be predicted.

FIGS. 13A and 13B explain, in detail, the firmware implement of the speed compensation process the CPU 17 performs. A vector can be rotated by using a rotation operator. Therefore, the vectors of the phase servo pattern segments Odd 1a and, Odd 1b are subjected to rotation correction (i.e., speed compensation). The vectors so corrected are used as the result of the DFT operation performed on the third phase servo pattern (Odd). The phase servo demodulation can thereby be accomplished. In FIGS. 13A and 13B, θ is a value attain by multiplying the seek speed by a constant.

As has been described, even if the disk 11 has a higher track density and the seek speed proportionally increase, a significant vector length can be calculated from the result of the DFT operation (integration) in the embodiment, by shortening the section over which the phase servo pattern is integrated. Hence, even if the head 13 is moved at high seek speed, phase servo demodulation can be achieved to generate position data (phase data) from which the position of the head 13 can be reliably detected. In other words, the highest speed can be raised, at which the phase servo control can demodulate the phase servo pattern.

(Exemplary Applications of the Embodiment)

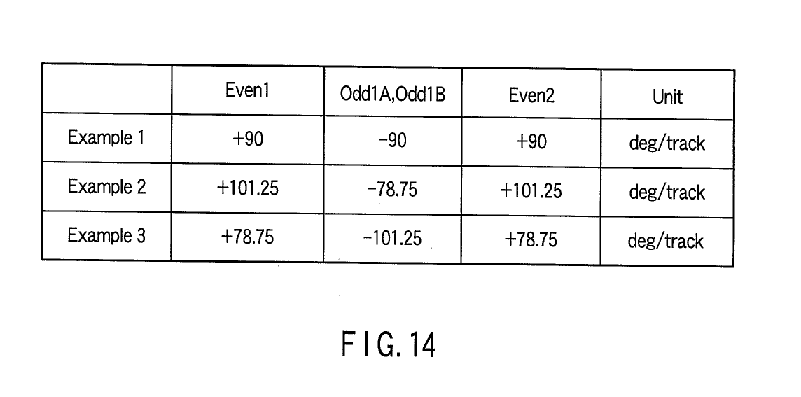

FIG. 14 is a diagram showing Examples 1, 2 and 3, in each of which the phase servo pattern segments Even 1, Odd 1A, Odd 1B and Even 2 have specific phase differences (degrees), respectively, for any two adjacent tracks (cylinders).

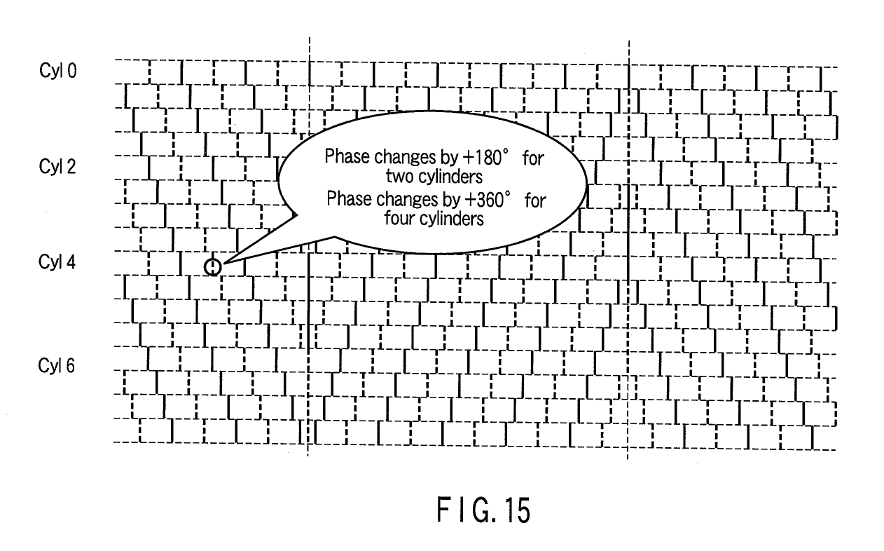

FIG. 15 is a diagram explaining Example 1 shown in FIG. 14. In FIG. 15, Cy10 to Cy16 indicate cylinders. In Example 1, if the head 13 moves over the phase servo burst signal 44 composed of segments Even 1, Odd 1A, Odd 1B and Even 2 and existing in any one of the cylinders Cy12 to Cy16, a phase difference of +180° will develop as the head 13 moves from one cylinder to the next cylinder.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk storage apparatus comprising:
a disk having a servo area in which first, second and third phase servo patterns are recorded, the second phase servo pattern being in phase with the first phase servo pattern, and the third phase servo pattern being inverse in phase to the first phase servo pattern and comprising at least two phase servo pattern segments; and
a servo demodulator configured to perform a phase servo demodulating process that includes integration operation on integration sections of the same ratio, using a read signal read from the servo area by a head.

2. The disk storage apparatus of claim 1, wherein the servo demodulator includes:
an operation module configured to perform integration on the first phase servo pattern, the second phase servo pattern and the phase servo pattern segments, over integration sections of the same ratio; and
a position calculation module configured to generate position information representing a position of the head, from the result of the integration performed by the operation module.

3. The disk storage apparatus of claim 2, wherein the position calculation module is configured to perform a speed compensation process using the result of the integration corresponding to the phase servo pattern segments from the operation module, thereby generating the position information.

4. The disk storage apparatus of claim 2, wherein the operation module is configured to perform discrete Fourier transformation as the integration, thereby calculating vectors corresponding to the first phase servo pattern, the second phase servo pattern and the phase servo pattern segments, respectively.

5. The disk storage apparatus of claim 4, wherein the position calculation module is configured to perform a speed compensation process synthesizing vectors corresponding to the phase servo pattern segments from the operation module, thereby generating the position information.

6. The disk storage apparatus of claim 1, wherein the third phase servo pattern includes a gap between the phase servo pattern segments.

7. The disk storage apparatus of claim 1, wherein the third phase servo pattern is free of gaps between the phase servo pattern segments.

8. The disk storage apparatus of claim 2, wherein each of the first and second phase servo patterns is composed of at least two phase servo pattern segments, and the operation module is configured to further perform integration on the phase servo pattern segments, over integration sections of the same ratio.

9. The disk storage apparatus of claim 1, wherein the first phase servo pattern, the second phase servo pattern and the third phase servo pattern have inter-track phase differences of +90°, −90°, and +90°, respectively.

10. A method for servo controlling, for use in a disk storage apparatus comprising a disk having a servo area in which first, second and third phase servo patterns are recorded, the second phase servo pattern being in phase with the first phase servo pattern, and the third phase servo pattern being inverse in phase to the first phase servo pattern and comprising at least two phase servo pattern segments, the method comprising:
reading a read signal read by a head from the servo area; and
performing a phase servo demodulating process that includes integration operation on integration sections of the same ratio, using the read signal read from the servo area.

11. The method of claim 10, wherein the performing phase servo demodulation includes:
performing integration on the first phase servo pattern, the second phase servo pattern and the phase servo pattern segments, over integration sections of the same ratio; and
generating position information representing a position of the head, from the result of the integration by the performing integration.

12. The method of claim 11, wherein the generating of position information includes performing a speed compensation process using the result of the integration corresponding to the phase servo pattern segments from the performing integration, thereby generating the position information.

13. The method of claim 11, wherein the performing integration includes performing discrete Fourier transformation as the integration, thereby calculating vectors corresponding to the first phase servo pattern, the second phase servo pattern and the phase servo pattern segments, respectively.
